(19) United States
(12) Patent Application Publication
(10) Pub. No.: US 2006/0271497 A1
(43) Pub. Date: Nov. 30, 2006

(54) Payment authorisation process

(76) Inventors: Andrew John Cullen, Auckland (NZ); Graeme John Dykes, Auckland (NZ)

Correspondence Address: JACOBSON HOLMAN PLLC, 400 SEVENTH STREET N.W., SUITE 600, WASHINGTON, DC, 20004, US

(21) Appl. No.: 11/439,214

(22) Filed: May 24, 2006

Related U.S. Application Data
(60) Provisional application No. 60/683,798, filed on May 24, 2005.

(51) Int. Cl. G06Q 99/00

(52) U.S. Cl. 705/64

(57) ABSTRACT

An electronic commerce process is described. The process compiling, at a merchant gateway, details of a transaction that a customer wishes to enter into with a merchant. In a secure communication session between the merchant gateway and a payment gateway sharing data that allows each gateway to uniquely identify communications relating to the transaction and sharing data representing at least a transaction amount in relation to the intended transaction. The merchant server causes a customer device to initiate a secure communication session with the payment gateway. During the secure communications session the customer device passing data to the payment gateway, the data enabling the payment gateway to identify the transaction. Payment aspects of a transaction are conducted in a secure communications session between the customer device and the payment gateway. When the payment aspects are concluded the payment server causes the customer device to initiate communication with the merchant gateway, the communication including data indicative of the transaction. Data indicative of the success or failure of the transaction is received by the merchant server. A merchant gateway programmed to implement the electronic commerce process is also described.

### BACKGROUND TO THE INVENTION

1. Field of the Invention

The present invention relates to an electronic commerce process that allows merchants to safely initiate financial transactions using a mix of secure and non-secure methods and to merchant gateways and payment gateways implementing this process.

2. Summary of the Prior Art

When a customer makes a purchase from a website, the merchant may need to redirect the customer to another website where the customer can securely enter their credit card details. This website is often referred to as a payment gateway.

The merchant needs to transmit the details of the transaction, and receive the outcome of the transaction in a secure manner. One approach, as illustrated in FIGS. 3A to 3C is implemented by the applicants' PXACCESS COM object. The merchant website 1 encrypts the transaction details and includes the encrypted transaction details in a redirect instruction 301 issued to the customer browser 12. The payment gateway 2 receives the details in the redirect page request and the encrypted transaction details are parsed from the URL and decrypted by the payment gateway 2 so that the payment gateway can continue the transaction. The payment gateway encrypts the result code and transmits 303 this to the merchant gateway in a redirect code issued to the customer. The result code is decrypted by the PXACCESS COM object at the merchant server.

The encryption of the transaction data:
Prevents customers altering the details of the transaction, e.g. altering the amount.
Prevents customers altering the outcome of the transaction, e.g. making the credit card transaction appear successful when it was declined.
Prevents other parties from viewing details of transactions as they are transmitted between websites.

Many merchant websites lack the ability to encrypt their transactions. For example, their webhosting service may prevent them from installing the necessary software for secure transactions such as the PXACCESS COM object. As a result, many handovers to payment gateways are insecure and can be a source of fraud by customers. Alternatively conscientious merchants are required to use a more expensive web hosting service.

### SUMMARY OF THE INVENTION

It is an object of the present invention to provide an electronic commerce process and/or apparatus for implementing an electronic commerce process, that goes some way towards overcoming the above disadvantages or which will at least provide merchants with a useful choice.

In a first aspect the present invention consists in an electronic commerce process comprising the steps of:

compiling, at a merchant gateway, details of a transaction that a customer wishes to enter into with a merchant;

in a secure communication session between said merchant gateway and a payment gateway sharing data that allows each gateway to uniquely identify communications relating to the transaction and sharing data representing at least a transaction amount in relation to the intended transaction;

causing the customer device to initiate a secure communication session with the payment gateway and pass data to the payment gateway enabling the payment gateway to identify the transaction;

completing the payment aspects of a transaction with said customer device in said secure communications session between said customer device and said payment gateway;

causing said customer device to initiate a communication to said merchant gateway, said communication including data indicative of the transaction; and

receiving data at said merchant gateway indicating the success or failure of the transaction.

According to a further aspect of the invention said step of sharing data between said merchant gateway and said payment gateway includes sharing data that will relate to data that will indicate the outcome of the transaction;

in said step of causing said customer device to initiate a communication to said merchant gateway, said communication includes data indicative of the outcome of the transaction; and

said merchant gateway determines the outcome for said transaction based on said shared outcome data and said data received from said customer device.

According to a further aspect of the invention said shared outcome data is generated by the payment gateway for each individual transaction and is stored by said payment gateway at least until said transaction has completed or is regeneratable by the payment gateway as necessary.

According to a further aspect of the invention the shared outcome data is randomly generated.

According to a further aspect of the invention said step of receiving data at said merchant gateway indicating the success or failure of the transaction includes the steps of initiating a secure communication session between said merchant gateway and said payment gateway and receiving data from said payment gateway at said merchant gateway indicating the success or failure of the transaction.

According to a further aspect of the invention said details of said transaction compiled at said merchant gateway comprises one or more of a transaction amount, a customer identifier and an indicator of transaction type such as refund, payment, authorisation for future transaction or recurring transaction.

According to a further aspect of the invention said shared data that allows each gateway to uniquely identify communications relating to the transaction comprises data generated by said payment gateway as an encryption of at least data relating to said transaction and transmitted to said merchant gateway.

According to a further aspect of the invention said shared data that allows each gateway to uniquely identify communications relating to the transaction comprises data generated by said payment gateway and transmitted to said merchant gateway.

According to a further aspect of the invention said shared transaction identity data comprises a unique identifier generated by said payment gateway as an encryption of at least data relating to said transaction.

According to a further aspect of the invention data relating to said transaction may include the merchant ID and/or time stamp data related to said transaction.

According to a further aspect of the invention said transaction details shared between said merchant gateway and said payment gateway allow for pre-stored customer payment data, and may include a customer identifier or an indication to allow for the storing of customer details for future transactions.

According to a further aspect of the invention the payment gateway may store, in relation to said merchant, customer details for customers associated with said merchant along with the customer identifiers supplied by said merchant.

According to a further aspect of the invention the indication for storing customer details for future transactions may comprise a said customer identifier for which the payment gateway has no record.

According to a further aspect of the invention the customer identifier may be a customer identifier generated by the payment gateway in a previous transaction and supplied to the merchant gateway in association with that earlier transaction.

According to a further aspect of the invention causing the customer device to initiate a secure communication session with the payment gateway includes supplying data to said customer device for initiating a request to said payment gateway, the data for the request including a transaction identifier.

According to a further aspect of the invention said request is an HTTP request and said data is a URL.

According to a further aspect of the invention the URL may include the payment gateway fully qualified name and a transaction identifier in the page address.

According to a further aspect of the invention the URL may be part of a redirect code or an HTML link for display on the customer device.

According to a further aspect of the invention said secure communication session between said customer device and said payment gateway, said payment gateway may request confirmation to store customer details for future use, and where consent is indicated, storing said details for future use in association with a customer identifier.

According to a further aspect of the invention the customer identifier may be a customer identifier associated with a merchant so that the details are stored in association with the customer identifier and the merchant identifier.

According to a further aspect of the invention said customer identifier is generated by the payment gateway and returned to the merchant gateway for future use.

According to a further aspect of the invention in said secure communication session between said customer device and said payment gateway, said payment gateway may request confirmation to use pre-stored customer details, and if said confirmation is provided by said customer device, said payment gateway retrieving pre-stored customer details from a database based on a customer identifier supplied by said merchant gateway in relation to said transaction.

According to a further aspect of the invention said step of causing said customer device to initiate a communication to said merchant gateway comprises supplying data for a request to said customer device, the data of the request including the transaction identifier.

According to a further aspect of the invention said request is an HTTP request and the data is a URL.

According to a further aspect of the invention the URL includes the merchant gateway full qualified name and the transaction identifier in the page address.

According to a further aspect of the invention the URL is part of a redirect code or an HTML link.

According to a further aspect of the invention said payment gateway generates a customer identifier for the customer in relation to the transaction, the payment gateway includes data indicating the customer identifier in the data for the customer device request to the merchant gateway.

According to a further aspect of the invention causing the customer device to initiate a secure communication session with the payment gateway includes supplying an HTTP request to said customer device for initiating a request to said payment gateway, the data for the request including a transaction identifier.

According to a further aspect of the invention said step of causing said customer device to initiate a communication to said merchant gateway comprises supplying an HTTP request to said customer device, the data of the request including the transaction identifier.

In a second aspect the present invention consists in a merchant gateway programmed to implement an electronic commerce process, said program comprising:

means for compiling transaction data in an interactive session with a customer,

means for initiating a secure communication session with a payment gateway, providing said payment gateway with details of said transaction and sharing with said payment gateway at least data indicating a unique identifier for said transaction,

means for causing said customer device to initiate a secure communication session with said payment gateway associated with said unique transaction identifier,

means for processing communications received from a customer device to confirm completion of a transaction; and

means for determining the outcome of said transaction.

According to a further aspect of the invention said means for sharing data with said payment gateway shares data that will be used to communicate the outcome of the transaction;

said means for processing communications received from a customer device to confirm completion of a transaction extracts result data from said communication; and

said means for determining the outcome of said transaction shared determines the outcome on the basis of said outcome data and said result data.

According to a further aspect of the invention said means for sharing data with said payment gateway receives data from said payment gateway that will be used to communicate the outcome of the transaction and stores said received data for later reference in relation to said transaction.

According to a further aspect of the invention said means for determining the outcome of said transaction includes means for initiating a secure communication session with said payment gateway to confirm the outcome of said transaction.

According to a further aspect of the invention said means for compiling the transaction data include means for receiving or calculating a transaction amount.

According to a further aspect of the invention said means for compiling transaction data include means for receiving or retrieving a customer identifier.

According to a further aspect of the invention said means for compiling a transaction include means for receiving an indication of transaction type.

According to a further aspect of the invention said means for providing said payment gateway with details of said transaction provides at least said transaction amount and said indicator of said transaction type (where applicable).

According to a further aspect of the invention said means for providing said payment gateway with details of said transaction includes a customer identifier in said transaction data or includes an indication to store customer details in said transaction data.

According to a further aspect of the invention said means for sharing data indicating a unique identifier for said transaction with said payment gateway comprises means for receiving data indicating a unique identifier from said payment gateway and storing said identifier in association with the details of said transaction.

According to a further aspect of the invention said means for causing said customer device to initiate a secure communication session with said payment gateway supplies data for a request to said customer device, the data of the request including data indicating the transaction.

According to a further aspect of the invention the request is an HTTP request and the data is a URL.

According to a further aspect of the invention the URL includes the payment gateway fully qualified name and the transaction identifier in the page address.

According to a further aspect of the invention the URL is part of a redirect code or an HTML link.

According to a further aspect of the invention said merchant gateway program includes means for determining a customer identifier from said communications received from said customer device following completion of the transaction.

According to a further aspect of the invention said merchant gateway program includes a database, or means for accessing a database, of at least transaction details, and preferably also customer details, to store and retrieve transaction and/or customer details as necessary.

According to a further aspect of the invention said means for compiling the transaction data include means for receiving or calculating a transaction amount;

said means for compiling a transaction include means for receiving an indication of transaction type;

said means for providing said payment gateway with details of said transaction provides at least said transaction amount and said indicator of said transaction type (where applicable); and

said means for determining the outcome of said transaction includes means for initiating a secure communication session with said payment gateway to confirm the outcome of said transaction.

According to a further aspect of the invention said means for compiling the transaction data include means for receiving or calculating a transaction amount;

said means for compiling a transaction include means for receiving an indication of transaction type;

said means for compiling transaction data include means for receiving or retrieving a customer identifier;

said means for providing said payment gateway with details of said transaction includes at least said transaction amount, said indicator of said transaction type (where applicable), a customer identifier or an indication to store customer details in said transaction data; and

said means for determining the outcome of said transaction includes means for initiating a secure communication session with said payment gateway to confirm the outcome of said transaction.

According to a further aspect of the invention said means for causing said customer device to initiate a secure communication session with said payment gateway supplies an HTTP request to said customer device, the data of the request including data indicating the transaction.

In a third aspect the present invention consists in a merchant gateway programmed to:

parse incoming communications to recognise
(a) an indication that a customer intends to complete a transaction, and
(b) an indication that a customer has completed a transaction with a payment gateway;

respond to instance (a) by initiating a secure communication session with a payment gateway to initialise the transaction with the payment gateway, and then handing off the customer device to the payment gateway; and

respond to instance (b) by extracting data indicating the identity of the transaction to which the communication relates and confirming the result of the transaction.

According to a further aspect of the invention said step of initialising the transaction with the payment gateway comprises supplying details of the transaction to the payment gateway, receiving a unique transaction identifier from the payment gateway, and said parsing incoming communications to recognise an indication that a customer has completed a transaction with a payment gateway comprises recognising the presence of a unique transaction identifier in said request.

According to a further aspect of the invention said step of initialising said transaction with the payment gateway includes receiving data representative of possible transaction outcomes, and said step of confirming the result of the transaction comprises extracting data from said request and comparing said extracted data with said outcome data received from said payment gateway in said session initialising said transaction.

According to a further aspect of the invention said step of confirming the result of said transaction includes initiating a secure communication session with said payment gateway to confirm the outcome for said transaction with said payment gateway, including supplying said identifier to said payment gateway for said payment gateway to identify said transaction.

In a fourth aspect the present invention consists in a payment gateway programmed to implement an electronic commerce process, said program comprising:

means for participating in a secure communication session with a merchant gateway, receiving details of an intended transaction and sharing with said merchant gateway at least data indicating a unique identifier for said transaction,

means for participating in a secure communication session with a customer device to receive payment data,

means for determining authorisation of a transaction according to said transaction details received from said merchant gateway and payment data received from said customer device,

means for causing said customer device to initiate a communication with said merchant gateway, said communication including data indicative of said unique transaction identifier, and

means for communicating data to said merchant gateway indicative of the outcome of said transaction.

According to a further aspect of the invention said means for participating in a secure communication session with said merchant gateway shares data that will be used to communicate the outcome of the transaction; and

said means for communicating data indicating the outcome of said transaction causes said communication from said customer device to said merchant gateway to include data indicating the outcome of said transaction that is related to said data shared with said merchant gateway in said secure communication session.

According to a further aspect of the invention said shared transaction identity data comprises a unique identifier generated by said payment gateway as an encryption of at least data relating to said transaction.

According to a further aspect of the invention said means for communicating data indicating the outcome of said transaction to said merchant gateway comprises means for participating in a secure communication session with said merchant gateway including receiving an indication of a unique identifier for a transaction and providing data indicative of the outcome of said transaction to said merchant gateway.

According to a further aspect of the invention said means for sharing data indicating a unique identifier for said transaction with said merchant gateway comprises means for generating a transaction identifier for said transaction and means for supplying said transaction identifier to said merchant gateway.

According to a further aspect of the invention said transaction identifier comprises a unique identifier generated by said payment gateway as an encryption of at least data relating to said transaction.

According to a further aspect of the invention said means for receiving details of an intended transaction includes means for receiving a customer identifier and said means for participating in a secure communication session with a customer device to receive payment data includes means for retrieving customer payment data from a customer database.

According to a further aspect of the invention said means for receiving details of an intended transaction includes means for receiving an indication to store payment data for a customer for future transactions, and said means for participating in a secure communication session with a customer device includes means for receiving confirmation to store customer details and means for storing customer details in a customer database.

According to a further aspect of the invention said means for causing said customer device to initiate a communication with said merchant gateway supplies data for a request to said customer device, the data for the request including a transaction identifier.

According to a further aspect of the invention the request is an HTTP request and the data is a URL.

According to a further aspect of the invention the URL includes the merchant gateway fully qualified name and the transaction identifier in the page address.

According to a further aspect of the invention the URL is part of a redirect code or an HTML link.

According to a further aspect of the invention said means for causing said customer device to initiate a communication with said merchant gateway supplies an HTTP request to said customer device, the data for the request including a transaction identifier.

In a fifth aspect the present invention consists in a payment gateway programmed to:

parse incoming communications to recognise
(a) an indication that a merchant wishes to set up a transaction for completion,
(b) an indication that a customer wishes to complete the payment part of a transaction;

respond to instance (a) by participating in a secure communication session with said merchant gateway to initialise the transaction; and

respond to instance (b) by participating in a secure communication session with a customer device, including extracting data indicating the identity of the transaction to which the communication session relates and receiving payment data, confirming a payment authorisation on the basis of said transaction data and said payment data, and then handing off the customer device to the merchant gateway and communicating an outcome of the transaction to said merchant gateway.

According to a further aspect of the invention said payment gateway is programmed to share data that will be used to indicate the outcome of transaction with a said merchant gateway at the time of initialising a transaction; and

to communicate said outcome to said merchant gateway by including data associated with said outcome for said transaction in data provided to said customer device for said hand off to said merchant gateway.

According to a further aspect of the invention said payment gateway is programmed to communicate said outcome of said transaction to said merchant gateway by parsing incoming communications to recognise:

(c) an indication that a merchant gateway wishes to confirm the outcome of a transaction; and

responding to instance (c) by participating in a secure communication session with said merchant gateway, extracting data indicating the identity of the transaction to which the session relates and confirming the result of the transaction associated with said transaction identity to said merchant gateway.

According to a further aspect of the invention data indicating the identity of the transaction comprises a unique identifier generated by said payment gateway as an encryption of at least data relating to said transaction.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

One preferred implementation of the present invention will be described with reference to the accompanying drawings.

FIG. 1 is a diagram illustrating the entities involved in the transaction, these entities communicating over the Internet,

FIGS. 2A to 2J illustrate the sequence of communications between the three entities illustrated in FIG. 1,

FIGS. 3A to 3C illustrate the sequence of transactions implemented in typical prior art payment systems,

FIGS. 4A is example XML code for starting the transaction, and

FIG. 4B is example XML code for providing a merchant gateway with a payment gateway address.

### DETAILED DESCRIPTION

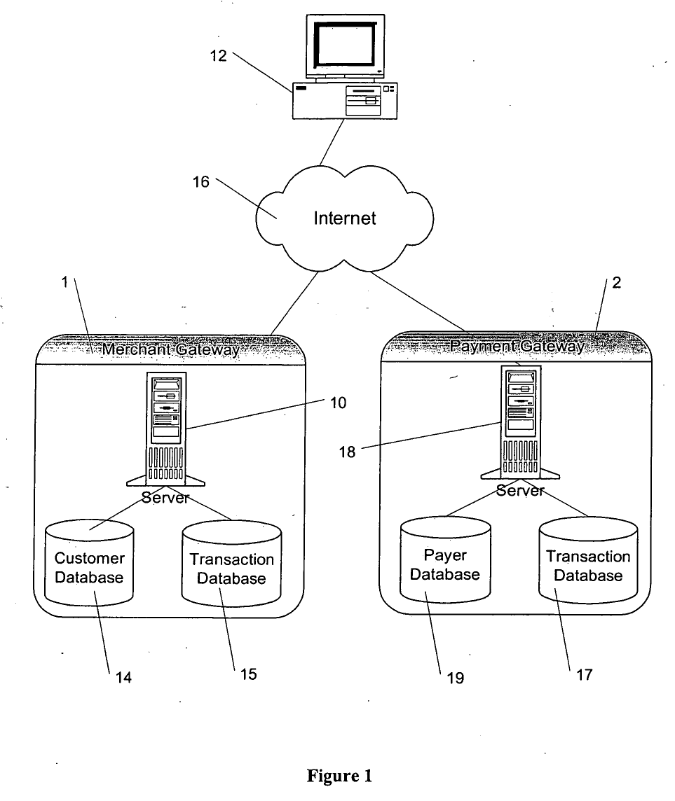

The present invention is intended for particular use in an e-commerce environment where a merchant is involved in financial transactions. The merchant may sell or receive payment for physical goods such as cut flowers, clothing or books, for services such as professional services, utilities or local government charges, or for other material, such as software, information or media content, (over an electronic communication network such as the Internet (16 in FIG. 1)).

A typical Internet merchant selling products (physical or otherwise) operates a “website”, and may make use of one of the many “shopping cart” software solutions that facilitate a merchant to present information concerning products that they offer and allow a prospective online customer to select products and compile an order. However for the purpose of the present invention any party wishing to receive credit card payments over the communication network will be considered a merchant (payee) and the party wishing to pay the customer (payor). For example a conventional service provider or conventional “bricks and mortar” store may provide an interface allowing clients to pay outstanding accounts using a credit card payment facility.

Transactions are not restricted to payments to a merchant from a customer. Transactions may also include authorisations (where card details are stored, the amount is authorised, but the card is only charged on the day that goods are shipped), refunds, or setting up recurring transactions (for example direct debit of utility charges). Transactions are discussed herein in relation to credit card payments. However it will be appreciated that payment gateways may operate as clearing houses for a wide range of transaction payment methods. For example a payment gateway may act as clearing house for electronic transfers from debit/bank accounts, gift cards, vouchers and the like. Transactions of all types are considered within the scope of the present invention.

Referring to FIG. 1, the merchant operates a merchant gateway 1 supplying content responsive to requests from customer devices 12. The customer device 12 may, for example, be an internet connected computer running browser software, requesting content and communicating with other Internet devices using HTTP. The customer device 12 may be any device capable of interacting with the merchant gateway using HTTP or any variation thereof, such devices including WAP capable telephones.

The merchant gateway 1 may comprise one or a plurality of servers 10, or may operate on a shared server such as those provided by web host providers. The merchant gateway 1 preferably will have access to a transaction database 15 and preferably has access to a customer database 14.

The merchant receives orders from a customer, and delegates the task of receiving payment for the transaction to a payment gateway 2. The payment gateway 2 comprises one or a plurality of servers and has access to a transaction database 17 and preferably has access the a customer details database 19. All communication between the customer device, the merchant gateway and the payment gateway is via public networks such as the Internet.

In the case of a typical Internet website the merchant gateway 1 runs a software program in the form of e-commerce software customised with a plurality of scripts, templates and data that are interpreted by the e-commerce software as required. The software (amongst other things) may actively generate and assemble page content to respond to HTTP requests, record data to storage as a record of site activity or to assemble a database of customers (for example database 14), and generate order lists or tasks for physical completion of orders. Many variations on this underlying configuration exist. The underlying implementation of the merchant gateway 1, so far as it interacts with the customer in compiling a transaction, and interacts with the customer after the payment portion of the transaction has been executed, does not form a part of the present invention.

The typical payment process of the present invention, implemented by the preferred merchant gateway 1 and payment gateway 2 according to the present invention involves a series of communication sessions between pairs of the customer device 12, merchant gateway 1 and payment gateway 2. This series of communication sessions is summarised in the sequence of illustrations 2A to 2J.

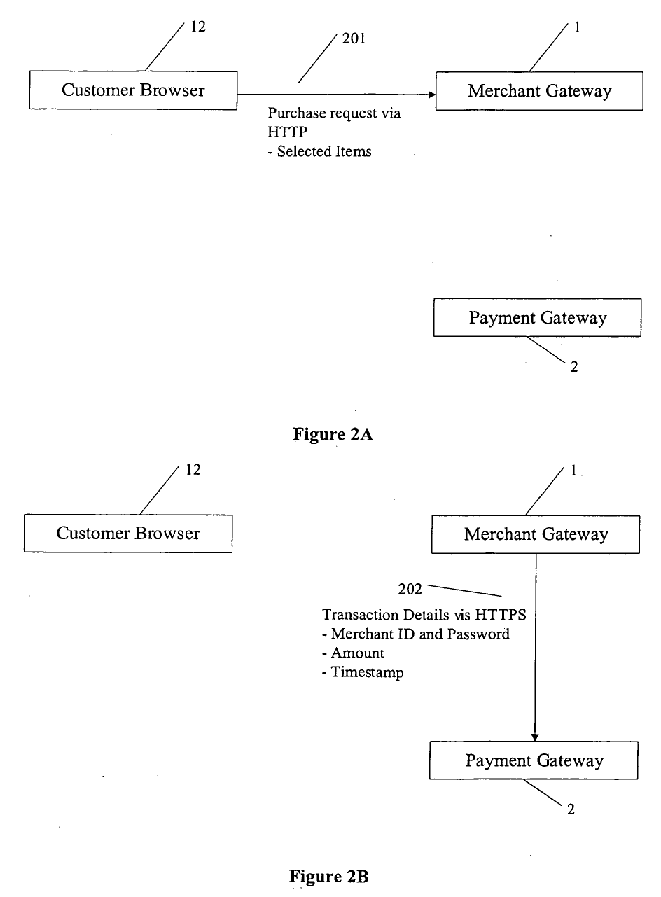

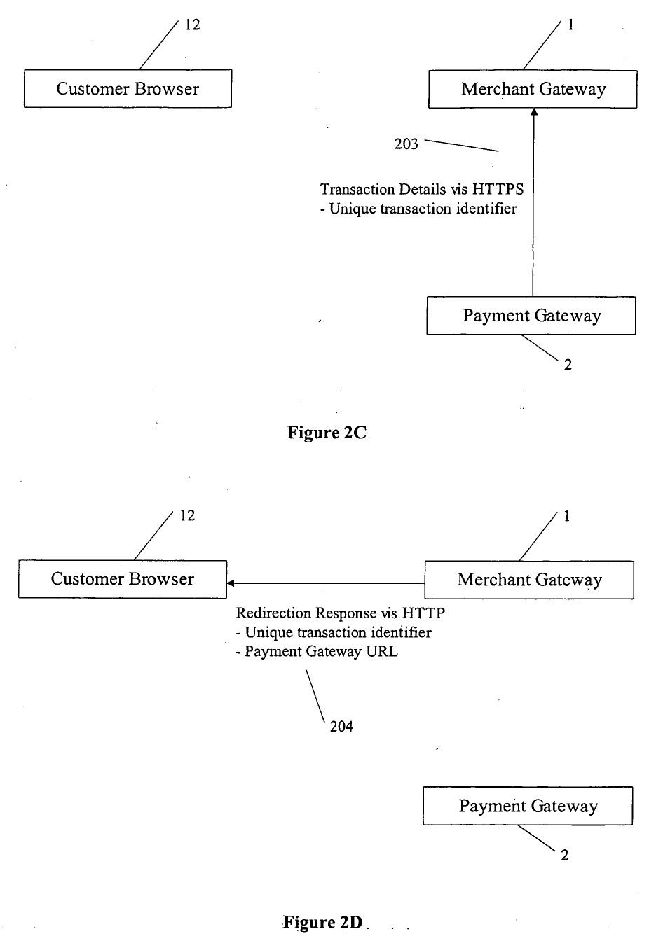

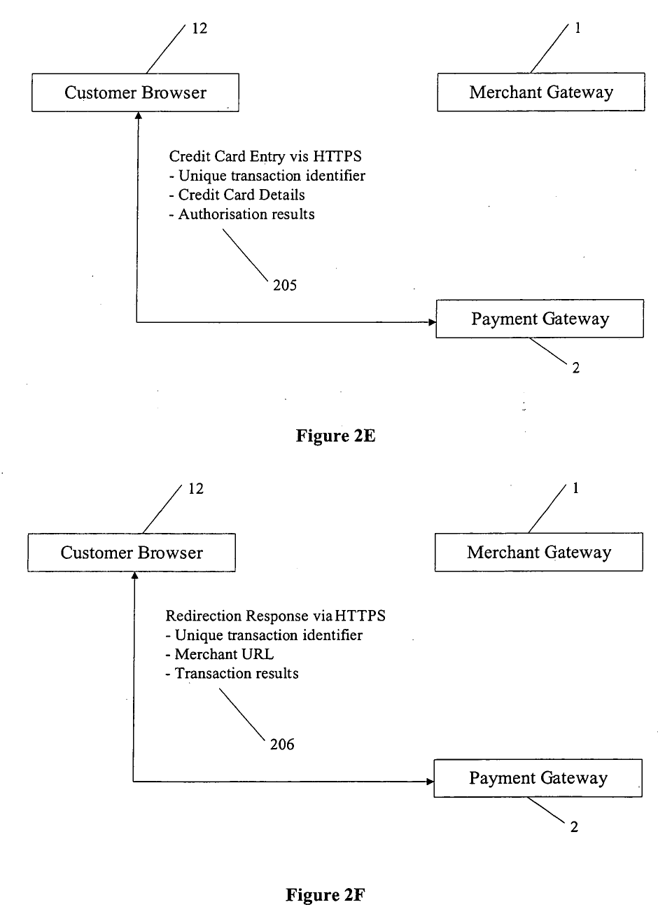

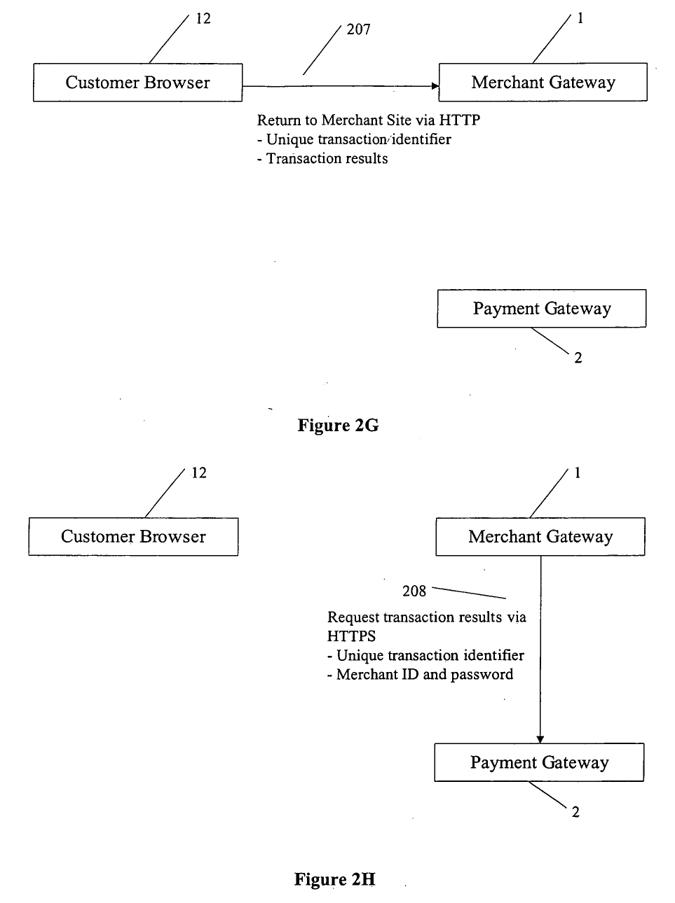

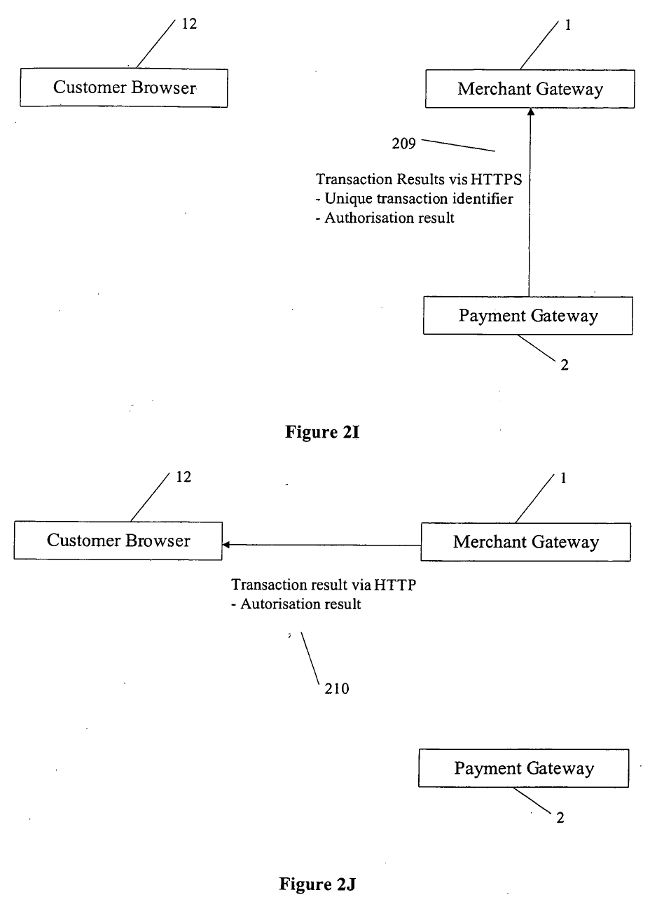

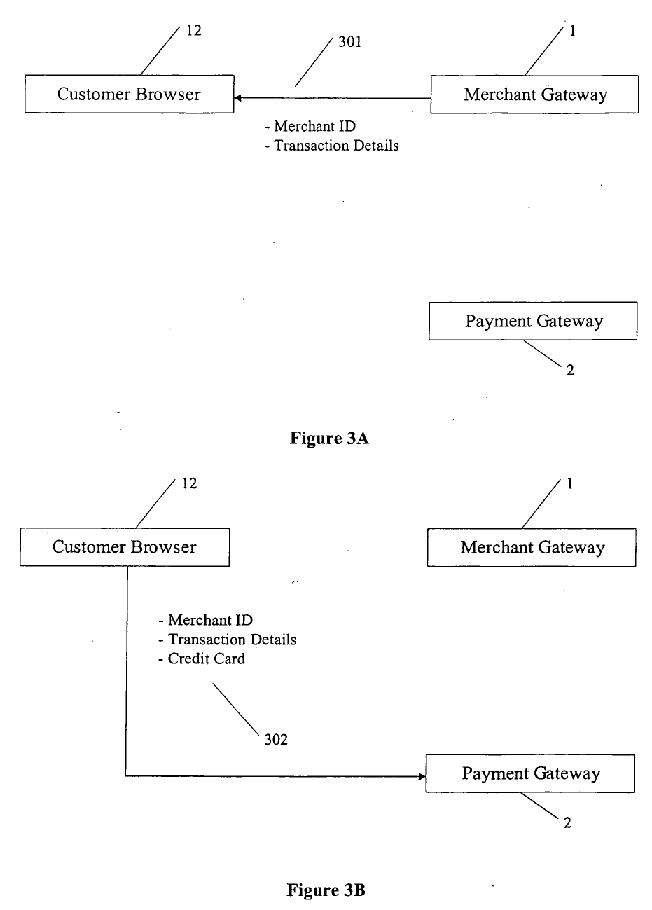

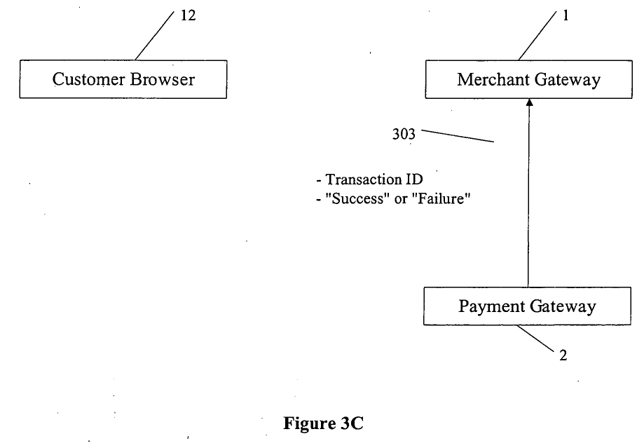

In the first session, illustrated in FIG. 2A, the customer device 12 communicates with the merchant gateway 1. In this session the customer device 12 provides 201 data to the merchant gateway 1 regarding a transaction. For a typical transaction this data will include selected items from an online catalogue, or identification of proposed payments to be made online. This data will also include an indication to the merchant gateway 1 that the customer wishes to complete the transaction. For example this may be instigated by a customer selecting a pay now or check out option.

As illustrated in FIG. 2B, once the merchant gateway 1 is informed of the customer's desire to complete the transaction, the merchant gateway 1 commences a secure communication session with the payment gateway 2. In this session the merchant gateway 1 initialises 202 a transaction with the payment gateway 2. This involves providing transaction details to the payment gateway 2 and sharing a transaction identifier with the payment gateway 2. The transaction identifier may be generated by either gateway. The identifier may be a simple unique code or an encryption of a selection of the transaction details. For example the transaction identifier may be generated by the payment gateway 1 as an encryption of the merchant identifier and time data. For example in the preferred embodiment the merchant gateway 1 supplies the payment gateway with login information, in the form of merchant ID and password, an amount of the transaction, and time stamp data. As illustrated in FIG. 2C, in this session the payment gateway 2 returns 203 at least a unique transaction identifier to the merchant gateway 1.

As illustrated in FIG. 2D, the merchant gateway 1 then returns a redirection response to the customer browser. The redirection response 204 is preferably a combination of the transaction identifier received from the payment gateway 2 and the payment gateway URL.

In accordance with the redirection command, the customer device 12 initiates a secure communication session (for example using HTTPS) with the payment gateway 2. In return the payment gateway 2 requests details for the intended payment, including customer payment details. The payment gateway 2 recalls the transaction details provided by the merchant gateway 1 on the basis of the unique transaction identifier extracted from the customer device 12 request. The payment gateway 1 may recall the transaction details by decrypting a previously encrypted transaction identifier to obtain the transaction details.

The payment gateway 2 processes the transaction with the appropriate third party credit provider in the usual manner. How the payment gateway 2 processes the transaction is not relevant to the present invention. The payment gateway 2 may, at this juncture, provide an indication of the authorisation result to the customer. Alternatively this may be left to the merchant gateway 1 at a later point in the process.

After processing the transaction details with the third party credit provider the payment gateway 2 hands off the customer device 12 to the merchant gateway 1, as illustrated in FIG. 2F. The payment gateway 2 issues 206 a redirection command to the customer browser. The command may be a combination of the unique transaction identifier, the merchant URL and data indicating the transaction result.

As illustrated in FIG. 2G, the customer device responds to this redirection command by issuing 207 a request to the merchant gateway 1 including the unique transaction identifier and the data indicating the transaction results. The merchant gateway 1 then continues to communicate with the customer device 12, including presenting the customer device with an indication of the transaction result. This step is illustrated in FIG. 2J.

Before communicating the authorisation result to the customer device the merchant gateway 1 may optionally seek confirmation of the transaction result from the payment gateway 2. As illustrated in FIG. 2H, the merchant gateway 1 may initiate a secure session 208 with the payment gateway 2, providing login details such as merchant ID and password and the unique transaction identifier. The payment gateway 2 may identify the transaction results from the unique transaction identifier, and return 209 the transaction result, with the transaction identifier, to the merchant gateway 1 as illustrated in FIG. 2I.

This process is implemented by software operating on the merchant gateway 1 and software operating on the payment gateway 2. Although the customer device 12 participates in this process, its operation, apart from as a user input device, is an automatic result of the redirection commands issued by the merchant gateway 1 and payment gateway 2.

The relevant operation and programming of the merchant gateway 1 and payment gateway 2 are described in more detail below.

The merchant gateway 1 compiles data representing the details of the intended transaction with the customer in an online interactive session between the merchant gateway 1 and the customer Internet device 12. The merchant gateway 1 may draw some of this data from a database 14 of pre-existing customer details. The essential transaction specific data for completing the credit card payment are the transaction amount and the transaction currency (which may be predetermined). Optionally the data may include a customer identifier. This option may be used where the intended payment gateway 2 provides the facility for storing client data. Optionally the data may include a flag to request the payment gateway 2 store the customer payment details for future transactions with the same customer.

According to the preferred embodiment of the present invention, the merchant gateway 1 is programmed to parse HTTP requests to recognise an indication from a customer device 12 that the customer wishes to complete a given transaction. For example the merchant gateway 1 may search the HTTP request for a predetermined code. On identifying the predetermined code the merchant gateway 1 program initiates a secure communication, for example an HTTPS session, between the merchant gateway 1 and a predetermined payment gateway server 2. The merchant gateway 1 is programmed to send the compiled transaction details to the payment gateway 2 once the secure communication is in place, for example once the SSL handshake is completed. The payment gateway 2 software may require merchant gateway identification. For that case the merchant gateway 1 is programmed to provide authentication details (for example user ID and password) on a unilateral basis in a format expected by the payment gateway 2.

The merchant gateway 1 may optionally be programmed to generate one time response codes for example representing success and failure of a transaction respectively, and send the one time response codes to the gateway in the HTTPS session. The one time codes may accompany the transaction details, may be provided in response to a payment gateway 2 request, or may be provided subsequently in the HTTPS session in a predetermined format allowing the payment gateway 2 to recognise and extract the response codes.

The merchant gateway 1 may also include time stamp data in the request. In the HTTPS session the merchant gateway 1 receives data from the payment gateway 2. The merchant gateway 1 is programmed to parse the received data to extract a code that uniquely identifies the transaction and to store the extracted code for later reference. Preferably the merchant gateway 1 is programmed to store the extracted code in a database together with transaction details, including the amount of the transaction, the material for which the payment is required, and customer details. For example, an online store supplying physical products may record identifiers of the physical products making up the order, customer identity and shipping information.

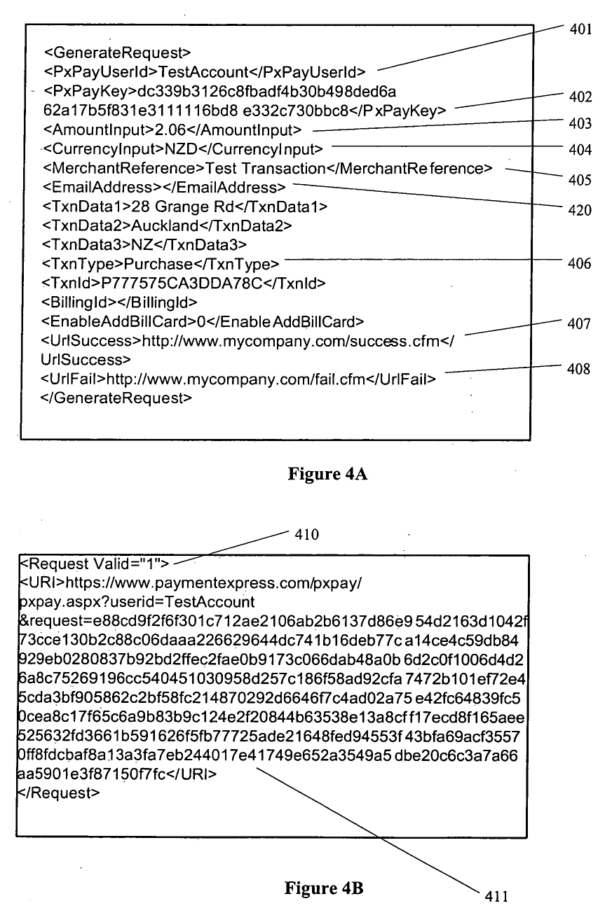

An XML example of the transaction details that the merchant gateway 1 sends to the payment gateway 2 is illustrated in FIG. 4A. The XML uses tags and must be well formed XML. The XML required for each request will include compulsory tags that must have input data and optional tags that may or may not be included, if optional tags are included the associated tag data may be empty. For example the email address tag pair 420 contains no data between the tag pairs.

In the illustrated example the request includes merchant user identification 401, a merchant password or passkey 402. The request also includes the amount 403 and currency 404 of the transaction and whether the transaction is a purchase, refund, authorisation or completion transaction 406. A URL 407 for redirecting the customer in the event of success and a URL 408 for redirecting the customer in the event that payment fails are also provided.

The merchant gateway 1 may also be programmed to extract redirection information from the data received from the payment gateway 2. The redirection information is data that should be passed to the customer device 12 to allow the customer device to communicate with the payment gateway 2 in relation to the transaction. Alternatively the payment gateway 2 may expect interaction requests from the customer device 12 based on the unique identifier code for the transaction.

Continuing the XML example above as seen in FIG. 4B in response to the request the payment gateway 2 provides information on the success or failure 410 of the request and a URL 411 to direct the customer to. Again the response is well formed XML.

The merchant gateway 1 program is programmed to end the HTTPS session after successfully extracting the transaction identifier and any other data required by the configuration of the payment gateway 2.

The overall outcome of the secure session is that the payment gateway 2 and the merchant gateway 1 each have a record for the transaction and share an expectation of the data with which the customer device 12 may rejoin the transaction with the payment gateway 2, and are able to identify the transaction to each other. This could be achieved with other information flow.

For example the merchant gateway 1 could provide the transaction identifier to the payment gateway 2. The payment gateway 2 could identify transactions by a combination of transaction identifier and merchant identifier, and this combination could form the basis of the redirect data for the customer device 12.

The merchant gateway 1 is programmed to return data to the customer device 12 that allows the customer device to initiate a communication with the payment gateway 2 in relation to the transaction. The data may for example comprise an address, such as a URL, uniquely associated with the transaction. The merchant gateway 1 program is preferably programmed to generate the URL from the unique transaction identifier and the identity of the payment gateway 2. For example the URL may include the HTTPS protocol identifier, the fully qualified name of the payment gateway 2 and a page reference that is the unique transaction identifier (or other data provided by the payment gateway for this purpose). Preferably the merchant gateway 1 program is programmed to provide this data in a form of an HTML redirect code in the HTML data returned to the customer device 12 in response to the customer device indicating an intention to complete the transaction. For example the HTML page may include a code in the form:

<meta http-equiv=“REFRESH”

content=“0;URL=https://payment_gateway_server_com/transaction_identifier”>.

This code would automatically cause the customer device to request the web page from the payment gateway. From the customer point of view the redirect is automatic.

Alternatively the merchant gateway may hand off the user in any other suitable way, for example the merchant gateway 1may return an HTML page including a hyperlink that the customer selects, for example in the form:

<a href=“http://payment_gateway_server_com/transaction_identifier”value=“click here to pay by credit card”/>

A combination of the automatic redirect and HTML page may be used to accommodate web browsers that warn about or prevent redirects to alternative domains.

As will be described below the customer device 12 now communicates directly with the payment gateway 2 to complete the payment side of the transaction at which point interaction will resume between the customer device 12 and the merchant gateway 1.

The merchant gateway 1 is programmed to parse all HTTP requests to determine for each request whether the request relates to a transaction for which details are stored in its database 15. For example, the merchant gateway 1 program may expect the HTTP request to include a predetermined flag data indicating that the request relates to a completing transaction. Alternately the merchant gateway program may expect such a request to include the unique transaction identifier and compare every request received against its database 15 of transaction identifiers or against part of the database (for example relating only to transactions on the same day). The merchant gateway 1 program is programmed to process requests that are identified as relating to a completing transaction by parsing the requests to determine the unique transaction identifier. The merchant gateway program may also parse the request for additional data, including a code that indicates success or failure of the transaction.

The merchant gateway 1 program retrieves transaction details from the merchant gateway transaction database according to the transaction identifier parsed from the HTTP request. The merchant gateway 1 may be programmed to determine success or failure of the transaction by comparing the extracted additional data with an expected success code and/or an expected failure code. The expected success code and the expected failure code (if any) may be a predetermined code, used between the merchant gateway and the payment gateway 2 for every transaction. However, preferably, the expected codes are the one time codes generated by the merchant gateway 1 program for each individual transaction, transmitted to the payment gateway 2 in the initial HTTPS session, and stored in the merchant gateway transaction database 15 by the merchant gateway program with the details of the transaction.

The merchant gateway 1 may also be programmed to extract a customer identifier from the request, and to store the customer identifier in its customer database 14 for use in relation to future transactions.

The merchant gateway 1 is programmed to return data to the customer device 12, for example in the form of HTML code, that will indicate the outcome of the transaction to the customer, and any further steps that the customer should take or that the merchant will arrange in relation to the matter. For example the data may present a web page indicating the success of the transaction and that the merchant will arrange shipping of the ordered items.

Optionally the merchant gateway 1 may be programmed to seek confirmation of the transaction outcome from the payment gateway 2 before returning the confirmation page to the customer device 12. This would be particularly sensible in an implementation of the invention that does not use one time codes to secure the data indicating success or failure of the transaction. In this case the merchant gateway 1 is programmed to initiate an HTTPS session with the payment gateway 2 after determining from the customer HTTP request that the payment for a transaction has been completed. The merchant gateway 1 is programmed to send the unique transaction code to the payment gateway 2 after HTTPS handshaking is completed and any login requirements have been met. The merchant gateway program parses replies from the payment gateway 2 to extract data confirming the outcome of the transaction. The merchant gateway program compares this data against expected data, either predetermined common codes indicating success or failure of a transaction or one time codes stored for the particular transaction. The merchant gateway program ends the HTTPS session once the transaction outcome data has been successfully received.

Accordingly, in addition to any other processing and parsing of incoming HTTP requests, the merchant gateway is programmed to identify. HTTP requests that indicate a willingness to complete a transaction and HTTP requests that indicate the completing of the payment part of a transaction. In the former case the software proceeds to set up the transaction with the payment gateway 2 and in the later case proceeds to determine the outcome of the payment part of the transaction from the request. The merchant gateway 1 is programmed to confirm the transaction outcome to the customer device 12 and to proceed with any necessary actions to complete the merchant's obligations under the transaction. Optionally the merchant gateway 1 software may seek confirmation of the transaction outcome directly from the payment gateway 2.

The payment gateway 2 is programmed to complete the actions required by the payment gateway 2 in the transaction. The payment gateway 2 includes program instructions for setting up a transaction at the request of a merchant gateway 1, completing the payment side of the transaction directly with the customer device, communicating the transaction outcome to the merchant gateway 1 via the customer device 12 and responding to merchant gateway requests regarding the outcome of a specified transaction.

The payment gateway 2 is configured to receive HTTPS sessions, and accordingly the payment gateway 2 is configured with a SSL certificate. It should be noted that the present system avoids the need for the merchant gateway 1 or customer device 12 to have an SSL certificate, as HTTPS sessions are initiated in each case by the merchant gateway 1 and the customer device 12 with the payment gateway 2.

The payment gateway 2 includes or has read and write access to, a database 17 of transaction details. The payment gateway 2 software may also include, or have read and write access to, a database 19 of customer details, to store and retrieve preferred payment details for pre-identified customers.

The payment gateway 2 is programmed to identify and respond distinctly to at least four distinct requests. A first request will include data indicating a merchant gateway, and/or a merchant, data comprising transaction information, optionally data including a customer identifier and optionally one time codes for success or failure. The payment gateway 2 software may be programmed to recognise this type of request from predetermined flag data, or by the format or presentation of data.

For a request of this type the payment gateway 2 is programmed to parse the request to extract information corresponding to a predetermined set of fields. At a minimum the payment gateway 2 extracts a payment amount and a merchant gateway identity. The server may also extract a merchant identifier, a customer identifier and one or more response codes. The payment gateway 2 and the merchant gateway 1 share a unique transaction identifier for the transaction. This may be generated by the merchant gateway 1, such as by encrypting the transaction details and transmitted to the payment gateway 2, or may be generated by the payment gateway 2.

In the preferred embodiment of the invention the payment gateway 2 is programmed to generate a unique transaction identifier as an encryption of the transaction details. Optionally the payment gateway 2 stores the extracted transaction information in the transaction database 17 in association with the transaction identifier. The payment gateway 2 is programmed to return the unique transaction identifier to the merchant gateway 1.

From this point the payment gateway 2 may expect to receive a request associated with that transaction from a customer device 12. The payment gateway 2 may pre-generate a response to an expected request, or may store a list of expected requests associated with transactions that have been initiated by merchant gateways. Alternatively the payment gateway software may respond to requests entirely on a dynamic basis, such as by decrypting the transaction identifier, or searching the transaction database 17 directly and assembling responses on an as needed basis.

The payment gateway 2 reviews all incoming requests for indications that they relate to preexisting transactions. This may be for example through flag data, or from the format of the data, or the payment gateway 2 may extract data from the incoming request according to a predetermined algorithm or may query its database based on that data, seeking a matching transaction.

For example, a transaction exists in the decrypted transaction identifier or the request corresponds with a transaction existing in the transaction database 17 can be used to indicate a customer commencing the payment process with the payment gateway 2, or used to indicate a customer completing the payment process with the payment gateway 2 (for example submitting the necessary payment details), or indicate a merchant gateway 1 requesting confirmation of the outcome of a transaction. The payment gateway may be configured so that the type of transaction is determined by flag data indicating the type of transaction, or by the format of the request.

Where the request indicates that it is the initiation of a payment session by a customer the payment gateway 2 is programmed to extract the transaction identifier from the request. The payment gateway 2 program preferably checks the record in the transaction database to determine whether the identified transaction has already been completed. In the case that the transaction data is stored in the encrypted identifier the absence of a record in the database may indicate that the transaction has not been completed, as the payment gateway transaction record may only be created after the customer pays or attempts to pay. If the database record indicates that the transaction has already been completed then the payment gateway 2 returns an HTML page indicating an error and the nature of the error to the customer device. The original completion of the transaction is unaffected. If the database record does not indicate that the transaction has already been completed then the payment gateway 2 software generates an HTML form which requests sufficient data from the customer to complete the transaction. The HTML form preferably includes an indication of the transaction amount, extracted from the database record, and one or more indications of confirmation such as a button object configured to “submit” the form. Where the transaction details stored in the database 17 or included in an encrypted identifier, indicate that the transaction is associated with a preloaded customer the form may include an option for the customer to use pre-recorded payment details. Furthermore the form may include an option to indicate that the payment gateway 2 should store payment details for future use.

Where the request indicates that it is a customer attempting to complete a payment, the gateway 2 is programmed to parse required information from the request data. The information may comprise credit account data such as credit account number, expiry date, card type and card holder, or confirmation to use pre-stored payment details. Where the form allowed for the user to indicate a desire that the payment gateway 2 store payment details for future use, the software also attempts to extract data confirming this selection. The software is programmed to generate a unique customer identifier and store the payment detail with the unique customer identifier in the customer database 19 at least for instances where it has been able to extract this confirmation. The software is programmed to extract payment data from the customer database 19 according to the customer identifier associated with the transaction identifier where the software has confirmed from the request data that the user has selected the option of paying using pre-stored payment details.

The payment gateway 2 software proceeds to use the payment details, whether extracted from the request or retrieved from the customer database 19, the merchant details (retrieved from a merchant database (not shown) using the merchant identifier) and the transaction amount to process the credit card transaction with the credit card issuer in the usual manner and, where applicable, credit the merchant account.

Merchant details are pre-stored by the payment gateway 2 such details as the merchants physical address bank account details, and credit card merchant provider.

Where the credit card company acknowledges that the amount requested can be transferred the payment gateway 2 completes the transfer of funds to the merchant account. The payment gateway 2 then creates a record in the transaction database or amends the transaction data already in the database. The payment gateway 2 is programmed to then generate a redirect URL for returning to the customer device 12. The redirect URL directs the customer device 12 back to the merchant gateway and includes an indication of the transaction (the transaction identifier) and device indication of the success of the transaction. For example the full URL may include the appropriate one time code extracted from the transaction database 17. The payment gateway 2 is programmed to return this URL to the customer device 12, for example in the form of an HTML redirect code. The payment gateway 2 is programmed to store an indication of the success of the transaction in the database 17 record for the transaction.

Where the credit card company denies the charge, the payment gateway 2 does not complete the transfer of funds to the merchant account. The payment gateway 2 is programmed to generate a URL comprising the merchant website address, an indicator of the transaction, for example the transaction identifier, and the one time code indicating failure extracted from the transaction database 17 record for this transaction. The payment gateway 2 is programmed to return this URL to the customer device 12, for example in the form of an HTML redirect code.

The payment gateway 2 program may store an indication of the failure of a transaction in the record for the transaction in the transaction database 17. Alternatively the payment gateway 2 program may only store an indication of the success of a transaction. There is arguably no difference between failure of an attempted payment and failing to attempt a payment.

Where the payment gateway 2 identifies a customer confirming they wish to store their payment details for future use the payment gateway 2 program may include a customer identifier in the redirect URL returned to the customer device 12. This may subsequently be extracted by the merchant gateway 1 and stored in the database 14 of customer records held by the merchant server.

The payment gateway 2 is programmed to identify requests including a transaction identifier and/or a flag indicating a request for confirmation of a transaction outcome and, for such requests, to query the transaction database for the outcome of the transaction. The payment gateway 2 is programmed to return a code indicating success of the transaction, for example a one time code for success stored in the transaction database 17, where the database record indicates that the transaction was successful. The payment gateway is programmed to otherwise return a code indicating failure of the transaction, for example a one time code for failure from the transaction record in the transaction database 17.

It should be noted that under this system a customer may attempt to complete the payment aspect of a transaction on multiple occasions following failure of initial attempts. Once the transaction is successfully completed the payment gateway 2 database 17 entry will indicate success and the payment gateway 2 will redirect the customer device 12 to the merchant gateway 1 with appropriate accompanying data for the merchant gateway to identify the transaction from the customer device request. That information may include the outcome of the transaction. The merchant gateway 1 may also subsequently confirm the outcome of the transaction with the payment gateway 2. Where the transaction is unsuccessful the merchant gateway 1 may facilitate the customer reattempting the transaction by redirecting the customer device 12 to the same URL as for the initial attempt. Alternatively the customer may initiate this re-request on their own account.

The key advantages of the described system are that the transactions are secured against customer or third party fraud throughout the transaction, and yet while it is not necessary for the merchant gateway 1 to include any proprietary software module for encrypted communications. Communications of the transaction data occur between the merchant gateway and the payment gateway direct using HTTPS/SSL without requiring the merchant gateway to have an SSL certificate. Customer payment data is transmitted from the customer to the payment gateway under an SSL session and the customer payment data is not available for access by the merchant. The transaction outcome is confirmed to the merchant gateway securely in the customer request following payment completion (for example the one time codes for success or failure). This notification can be subject of confirmation by the merchant gateway 1 if necessary. The merchant gateway 1 is always the initiator of secure sessions with the payment gateway 2 so does not require an SSL certificate.

1. An electronic commerce process comprising the steps of:
compiling, at a merchant gateway, details of a transaction that a customer wishes to enter into with a merchant;
in a secure communication session between said merchant gateway and a payment gateway sharing data that allows each gateway to uniquely identify communications relating to the transaction and sharing data representing at least a transaction amount in relation to the intended transaction;
causing the customer device to initiate a secure communication session with the payment gateway and pass data to the payment gateway enabling the payment gateway to identify the transaction;
completing the payment aspects of a transaction with said customer device in said secure communications session between said customer device and said payment gateway;
causing said customer device to initiate a communication to said merchant gateway, said communication including data indicative of the transaction; and
receiving data at said merchant gateway indicating the success or failure of the transaction.

2. An electronic commerce process as claimed in claim 1, wherein
said step of sharing data between said merchant gateway and said payment gateway includes sharing data that will relate to data that will indicate the outcome of the transaction;
in said step of causing said customer device to initiate a communication to said merchant gateway, said communication includes data indicative of the outcome of the transaction; and
said merchant gateway determines the outcome for said transaction based on said shared outcome data and said data received from said customer device.

3. An electronic commerce process as claimed in claim 2, wherein said shared outcome data is generated by the payment gateway for each individual transaction and is stored by said payment gateway at least until said transaction has completed or is regeneratable by the payment gateway as necessary.

4. An electronic commerce process as claimed in claim 1, wherein said step of receiving data at said merchant gateway indicating the success or failure of the transaction includes the steps of initiating a secure communication session between said merchant gateway and said payment gateway and receiving data from said payment gateway at said merchant gateway indicating the success or failure of the transaction.

5. An electronic commerce process as claimed in claim 1, wherein said details of said transaction compiled at said merchant gateway comprises one or more of a transaction amount, a customer identifier and an indicator of transaction type such as refund, payment, authorisation for future transaction or recurring transaction.

6. An electronic commerce process as claimed in claim 5, wherein said shared data that allows each gateway to uniquely identify communications relating to the transaction comprises data generated by said payment gateway as an encryption of at least data relating to said transaction and transmitted to said merchant gateway.

7. An electronic commerce process as claimed in claim 1, wherein said shared data that allows each gateway to uniquely identify communications relating to the transaction comprises data generated by said payment gateway and transmitted to said merchant gateway.

8. An electronic commerce process as claimed in claim 1, wherein causing the customer device to initiate a secure communication session with the payment gateway includes supplying an HTTP request to said customer device for initiating a request to said payment gateway, the data for the request including a transaction identifier.

9. An electronic commerce process as claimed in claim 8, wherein said step of causing said customer device to initiate a communication to said merchant gateway comprises supplying an HTTP request to said customer device, the data of the request including the transaction identifier.

10. A merchant gateway programmed to implement an electronic commerce process, said program comprising:
means for compiling transaction data in an interactive session with a customer,
means for initiating a secure communication session with a payment gateway, providing said payment gateway with details of said transaction and sharing with said payment gateway at least data indicating a unique identifier for said transaction,
means for causing said customer device to initiate a secure communication session with said payment gateway associated with said unique transaction identifier,
means for processing communications received from a customer device to confirm completion of a transaction; and
means for determining the outcome of said transaction.

11. A merchant gateway programmed to implement an electronic commerce process as claimed in claim 10, wherein
said means for sharing data with said payment gateway shares data that will be used to communicate the outcome of the transaction,
said means for processing communications received from a customer device to confirm completion of a transaction extracts result data from said communication; and
said means for determining the outcome of said transaction shared determines the outcome on the basis of said outcome data and said result data.

12. A merchant gateway programmed to implement an electronic commerce process as claimed in claim 11, wherein said means for sharing data with said payment gateway receives data from said payment gateway that will be used to communicate the outcome of the transaction and stores said received data for later reference in relation to said transaction.

13. A merchant gateway programmed to implement an electronic commerce process as claimed in claim 10, wherein said means for determining the outcome of said transaction includes means for initiating a secure communication session with said payment gateway to confirm the outcome of said transaction.

14. A merchant gateway programmed to implement an electronic commerce process as claimed in claim 11, wherein
said means for compiling the transaction data include means for receiving or calculating a transaction amount;
said means for compiling a transaction include means for receiving an indication of transaction type;
said means for providing said payment gateway with details of said transaction provides at least said transaction amount and said indicator of said transaction type (where applicable); and
said means for determining the outcome of said transaction includes means for initiating a secure communication session with said payment gateway to confirm the outcome of said transaction.

15. A merchant gateway programmed to implement an electronic commerce process as claimed in claim 11, wherein
said means for compiling the transaction data include means for receiving or calculating a transaction amount;
said means for compiling a transaction include means for receiving an indication of transaction type;
said means for compiling transaction data include means for receiving or retrieving a customer identifier;
said means for providing said payment gateway with details of said transaction includes at least said transaction amount, said indicator of said transaction type (where applicable), a customer identifier or an indication to store customer details in said transaction data; and
said means for determining the outcome of said transaction includes means for initiating a secure communication session with said payment gateway to confirm the outcome of said transaction.

16. A merchant gateway programmed to implement an electronic commerce process as claimed in claim 10, wherein said means for sharing data indicating a unique identifier for said transaction with said payment gateway comprises means for receiving data indicating a unique identifier from said payment gateway and storing said identifier in association with the details of said transaction.

17. A merchant gateway programmed to implement an electronic commerce process as claimed in claim 10, wherein said means for causing said customer device to initiate a secure communication session with said payment gateway supplies an HTTP request to said customer device, the data of the request including data indicating the transaction.

18. A merchant gateway programmed to implement an electronic commerce process as claimed in claim 10, wherein said merchant gateway program includes a database, or means for accessing a database, of at least transaction details, and preferably also customer details, to store and retrieve transaction and/or customer details as necessary.

19. A merchant gateway programmed to:
parse incoming communications to recognise
(c) an indication that a customer intends to complete a transaction, and
(d) an indication that a customer has completed a transaction with a payment gateway;
respond to instance (a) by initiating a secure communication session with a payment gateway to initialise the transaction with the payment gateway, and then handing off the customer device to the payment gateway; and
respond to instance (b) by extracting data indicating the identity of the transaction to which the communication relates and confirming the result of the transaction.

20. A merchant gateway as claimed in claim 19, wherein said step of initialising the transaction with the payment gateway comprises supplying details of the transaction to the payment gateway, receiving a unique transaction identifier from the payment gateway, and said parsing incoming communications to recognise an indication that a customer has completed a transaction with a payment gateway comprises recognising the presence of a unique transaction identifier in said request.

21. A merchant gateway as claimed in claim 19, wherein said step of initialising said transaction with the payment gateway includes receiving data representative of possible transaction outcomes, and said step of confirming the result of the transaction comprises extracting data from said request and comparing said extracted data with said outcome data received from said payment gateway in said session initialising said transaction.

22. A merchant gateway as claimed in claim 19, wherein said step of confirming the result of said transaction includes initiating a secure communication session with said payment gateway to confirm the outcome for said transaction with said payment gateway, including supplying said identifier to said payment gateway for said payment gateway to identify said transaction.

23. A payment gateway programmed to implement an electronic commerce process, said program comprising:
means for participating in a secure communication session with a merchant gateway, receiving details of an intended transaction and sharing with said merchant gateway at least data indicating a unique identifier for said transaction,
means for participating in a secure communication session with a customer device to receive payment data,
means for determining authorisation of a transaction according to said transaction details received from said merchant gateway and payment data received from said customer device,
means for causing said customer device to initiate a communication with said merchant gateway, said communication including data indicative of said unique transaction identifier, and
means for communicating data to said merchant gateway indicative of the outcome of said transaction.

24. A payment gateway programmed to implement an electronic commerce process as claimed in claim 23, wherein
said means for participating in a secure communication session with said merchant gateway shares data that will be used to communicate the outcome of the transaction; and
said means for communicating data indicating the outcome of said transaction causes said communication from said customer device to said merchant gateway to include data indicating the outcome of said transaction that is related to said data shared with said merchant gateway in said secure communication session.

25. A payment gateway programmed to implement an electronic commerce process as claimed in claim 23, wherein said means for communicating data indicating the outcome of said transaction to said merchant gateway comprises means for participating in a secure communication session with said merchant gateway including receiving an indication of a unique identifier for a transaction and providing data indicative of the outcome of said transaction to said merchant gateway.

26. A payment gateway programmed to implement an electronic commerce process as claimed in claim 23, wherein said means for sharing data indicating a unique identifier for said transaction with said merchant gateway comprises means for generating a transaction identifier for said transaction and means for supplying said transaction identifier to said merchant gateway.

27. A payment gateway programmed to implement an electronic commerce process as claimed in claim 26 wherein said transaction identifier comprises a unique identifier generated by said payment gateway as an encryption of at least data relating to said transaction.

28. A payment gateway programmed to implement an electronic commerce process as claimed in claim 23, wherein said means for causing said customer device to initiate a communication with said merchant gateway supplies an HTTP request to said customer device, the data for the request including a transaction identifier.

29. A payment gateway programmed to:
parse incoming communications to recognise
(c) an indication that a merchant wishes to set up a transaction for completion,
(d) an indication that a customer wishes to complete the payment part of a transaction;
respond to instance (a) by participating in a secure communication session with said merchant gateway to initialise the transaction; and
respond to instance (b) by participating in a secure communication session with a customer device, including extracting data indicating the identity of the transaction to which the communication session relates and receiving payment data, confirming a payment authorisation on the basis of said transaction data and said payment data, and then handing off the customer device to the merchant gateway and communicating an outcome of the transaction to said merchant gateway.

30. A payment gateway as claimed in claim 27, wherein
said payment gateway is programmed to share data that will be used to indicate the outcome of transaction with a said merchant gateway at the time of initialising a transaction; and
to communicate said outcome to said merchant gateway by including data associated with said outcome for said transaction in data provided to said customer device for said hand off to said merchant gateway.

31. A payment gateway as claimed in claim 27, wherein said payment gateway is programmed to communicate said outcome of said transaction to said merchant gateway by parsing incoming communications to recognise:
(c) an indication that a merchant gateway wishes to confirm the outcome of a transaction; and

32. responding to instance (c) by participating in a secure communication session with said merchant gateway, extracting data indicating the identity of the transaction to which the session relates and confirming the result of the transaction associated with said transaction identity to said merchant gateway.

33. A payment gateway programmed to implement an electronic commerce process as claimed in claim 32 wherein data indicating the identity of the transaction comprises a unique identifier generated by said payment gateway as an encryption of at least data relating to said transaction.
